(19) United States
(12) Patent Application Publication
(10) Pub. No.: US 2016/0346798 A1
(43) Pub. Date: Dec. 1, 2016

(54) FLUID TANK AND DISPENSER INCORPORATING SUCH A TANK

(71) Applicant: APTAR FRANCE SAS, Le Neubourg (FR)

(72) Inventor: Laurent DECOTTIGNIES, CERGY (FR)

(73) Assignee: APTAR FRANCE SAS, Le Neubourg (FR)

(21) Appl. No.: 15/111,893

(22) PCT Filed: Jan. 16, 2015
(86) PCT No.: PCT/FR2015/050107

§ 371 Date: Jul. 15, 2016

(30) Foreign Application Priority Data
Jan. 17, 2014 (FR) 1450373

(51) Int. Cl. B05B 11/00

(52) U.S. Cl. CPC B05B 11/3028; B05B 11/3047; B05B 11/3069; B05B 11/0054

(57) ABSTRACT

A fluid reservoir including a neck defining a wide opening that is closed by a dish in stationary and leaktight engagement with the neck. The dish has a main body in engagement with the neck and a stopper that is mounted on the main body in removable manner, the stopper being movable between a closed initial position in which the stopper is mounted on the main body in leaktight manner, and an open final position in which a feed opening is formed between the main body and the stopper.

The present invention relates to a fluid reservoir including a neck defining a wide opening that is closed by a dish in stationary and leaktight engagement with the neck. The reservoir is for associating with a dispenser member, such as a pump, so as to constitute a fluid dispenser. The term “dish” should be understood in its broadest sense, i.e. encompassing any closure, covering, or shutting element that is suitable for closing the wide opening of the neck, so as to preserve the fluid contained in the reservoir against any deterioration, contamination, or damage. By way of example, the term “dish” may extend to a lid, a stopper, a capsule, a top, a film, etc. The reservoir of the present invention finds an advantageous application as a refill or a cartridge that is suitable for associating with a fluid dispenser member, such as a pump. The reservoir should be closed in leaktight manner while it is not associated with the dispenser member. In contrast, once it is associated with the dispenser member, a feed opening makes it possible to pass the fluid stored in the reservoir to the dispenser member for dispensing each time the dispenser member is actuated. The advantageous fields of application of the present invention are the fields of cosmetics, pharmacy, and perfumery.

In the prior art, fluid reservoirs in the form of pots presenting a short and stocky configuration have been known for some time. In general, such pots include a neck defining a wide opening that is closed by a lid that is screw-fastened or snap-fastened. In a variant or in addition, the wide opening of the neck may also be closed by a film that is adhesively-bonded or heat-sealed on the edge of the neck. In the general field of reservoirs, it is also known to provide the neck with a membrane or a film that is perforated while the reservoir is being put into place on a dispenser member. By way of example, U.S. Pat. No. 5,025,950 and U.S. Pat. No. 5,642,838 are known.

Those prior-art closure elements present specific drawbacks associated with their design. A screw-fastener or tear-off lid may be coated in part with fluid that tends to dry or deteriorate over time. In addition, such a lid may be dropped and lead to soiling. The tear-off film presents additional drawbacks: not only is it difficult to remove, but it is also often in contact with the fluid, such that it too can lead to soiling. In addition, the films often tend to tear such that they become difficult to remove. With regard to membranes or films for perforating, such perforation can produce little bits of debris that become incorporated in the fluid stored in the reservoir.

U.S. Pat. No. 5,642,838 and U.S. Pat. No. 5,025,955 describe reservoirs that are fitted with dishes that form films that can be cut away in part such that they pivot while remaining connected to the reservoir. The opening thus created depends on the way in which the film has been cut away and the way in which it has been pivoted.

An object of the present invention is to remedy the above-mentioned drawbacks of the prior art by defining a fluid reservoir, e.g. of refill or cartridge type, that is fitted with a closure dish that is suitable for defining a feed opening that is guaranteed, of the right size, clean, and without creating a portion to be thrown away or to be perforated, and without leaving debris in the fluid.

To do this the present invention proposes a fluid reservoir including a neck defining a wide opening that is closed by a dish in stationary and leaktight engagement with the neck, the reservoir being characterized in that the dish comprises a main body in engagement with the neck and a stopper that is mounted on the main body in removable manner, the stopper being movable between a closed initial position in which the stopper is mounted on the main body in leaktight manner, and an open final position in which a feed opening is formed between the main body and the stopper. The dish is thus intended to remain in place in the wide opening of the neck, with only the stopper moving in order to create the feed opening. It should be observed that the feed opening is formed between the main body and the stopper, and not only by the main body. This means that the stopper is arranged in accurate and determined manner relative to the main body in the open final position. In other words, movement of the stopper does not cause it to fall in uncontrolled manner into the reservoir. However, the stopper is separate from the main body in its open final position. In a variant, it is also possible for the stopper to remain in contact with the main body in its open final position, while nevertheless forming a feed opening between them.

In an advantageous embodiment, the feed opening is annular. In other words, the feed opening extends around the stopper.

According to another advantageous characteristic, the stopper is movable axially in translation relative to the main body between its closed initial position and its open final position.

In another advantageous aspect of the invention, the stopper may include holder means via which the stopper is gripped by an external thrust element so as to move it from its closed initial position to its open final position. The external thrust element may advantageously be formed by the dispenser member that is for associating with the reservoir so as to constitute a fluid dispenser. The external thrust element thus holds the stopper in its open final position, with an accurate and determined arrangement relative to the main body of the dish. It can also be said that the stopper is secured to the main body of the dish in its closed initial position, and is secured to the external thrust element in its open final position.

According to another characteristic of the invention, the stopper may be snap-fastened in the main body in its closed initial position. The snap-fastening is advantageously leaktight. In a variant, the stopper in its closed initial position may be formed integrally as a single piece with the main body. By way of example, the stopper may be connected to the main body via an annular rupture zone, e.g. constituted by a thin wall portion.

In another aspect of the invention, the main body may define at least one annular sealing lip that projects upwards. Advantageously, the stopper is mounted in the annular sealing lip in its closed initial position. As mentioned above, the stopper may be snap-fastened or it may be formed integrally as a single piece. The annular sealing lip(s) advantageously co-operate with the dispenser member so as to create sealing between the reservoir and the dispenser member.

The invention also provides a fluid dispenser comprising a dispenser member, such as a pump, associated with a fluid reservoir as defined above. The dispenser member includes a thrust element that comes into engagement with the stopper so as to move it from its closed initial position to its open final position. Advantageously, the thrust element holds the stopper in its open final position.

According to another advantageous characteristic of the invention, the dispenser member includes a chamber in which the fluid is put under pressure, the chamber including at least one inlet that communicates with the reservoir, the inlet being arranged around the thrust element. By way of example, the inlet may be formed by a plurality of orifices that are arranged around the thrust element.

According to another characteristic of the invention, the dispenser member may form at least one annular sealing groove in which an annular sealing lip that is formed by the dish is received.

One of the principles of the invention is to make a fluid reservoir with a dish that includes a movable stopper that, while the reservoir is combined with a dispenser member (pump), is moved so as to create a feed opening that is defined between the main body and the stopper. It should be observed that the dish of the invention does not generate any waste or debris, given that the only movable element, namely the stopper, adopts an accurate and determined position relative to the remainder of the dish when the reservoir is associated with a pump or a valve.

The invention is described more fully below with reference to the accompanying drawings, which show an embodiment of the invention by way of non-limiting example, together with a variant.

In the drawings:

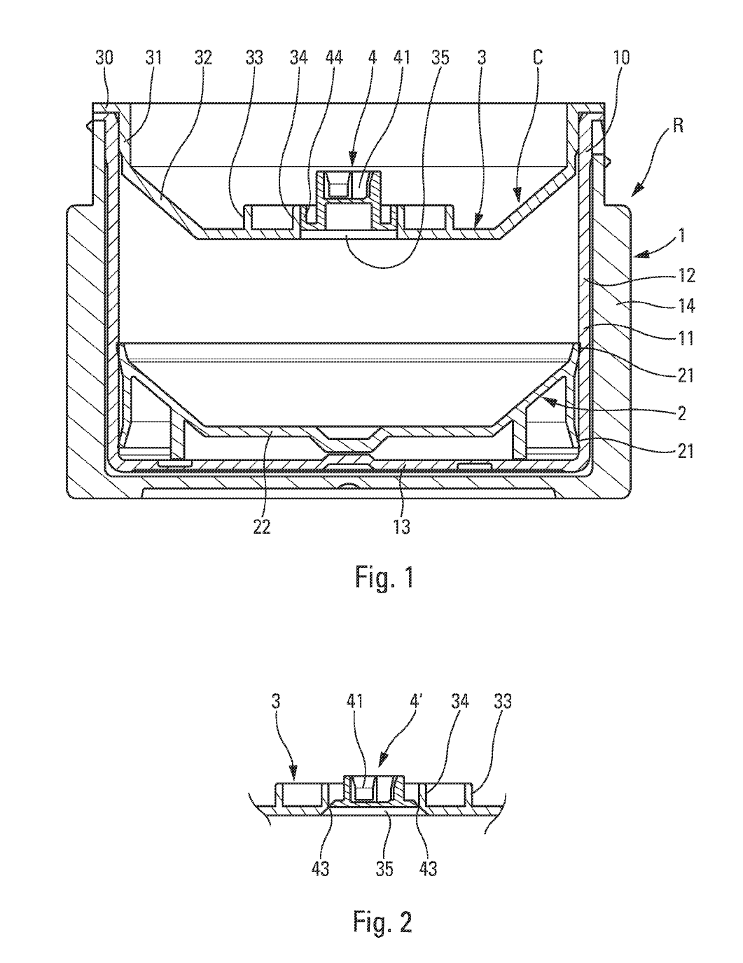

FIG. 1 is a vertical section view through a fluid reservoir of the invention;

FIG. 2 shows a variant embodiment of the dish of the invention;

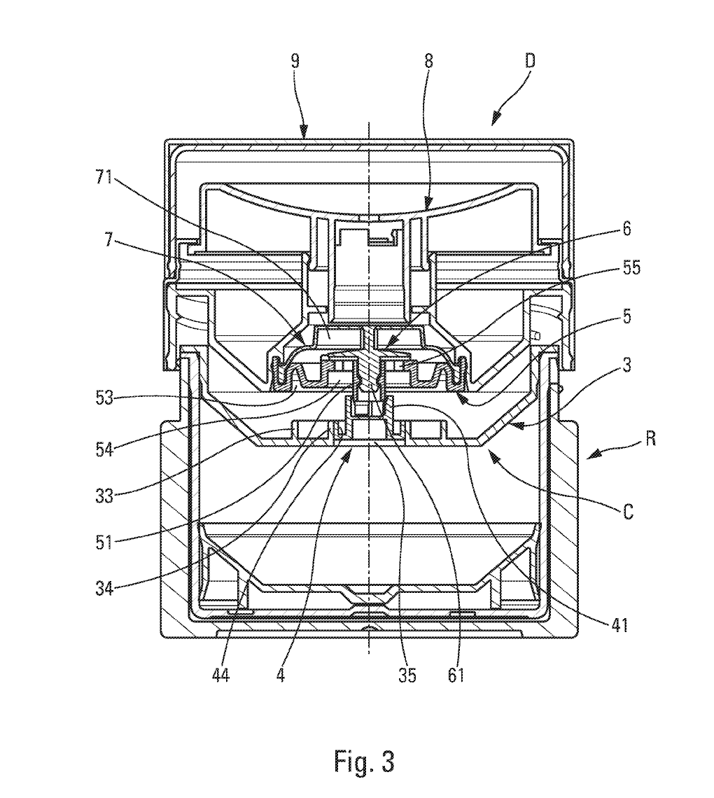

FIG. 3 is a vertical section view through a fluid dispenser in its non-assembled configuration;

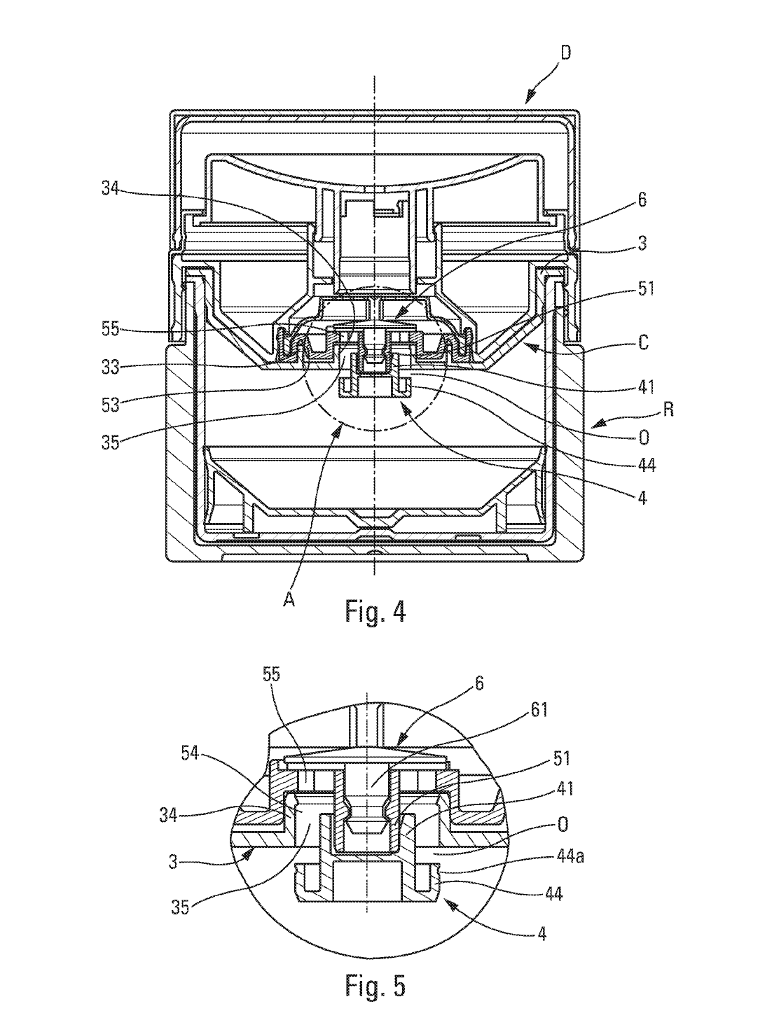

FIG. 4 is a view similar to the view in FIG. 3 in its assembled configuration; and

FIG. 5 is a larger-scale view of a detail A in FIG. 4.

Reference is made initially to FIG. 1 in order to describe in general a fluid reservoir made in accordance with the invention. The fluid reservoir, designated overall by the letter R, comprises a pot 1 that is relatively wide and short. The pot 1 includes a slide cylinder 11 that, at its top end, defines a neck 10 that forms a wide opening. At its bottom end, the slide cylinder 11 is closed by a bottom wall 13 that is optionally perforated by one or more vent holes. The pot 1 optionally includes an external packaging shell 14 that surrounds the cylinder 11 and the bottom wall 13. The neck 10 may advantageously form a rim that projects outwards and that bears against the top end edge of the packaging 14. An outside thread may also be provided at the neck 10 or the cover 14, as in FIG. 1.

A follower piston 2, advantageously formed with two annular sealing lips 21, is engaged to slide in leaktight manner inside the cylinder 11. The follower piston 2 includes a bottom plate 22 that is in contact with the bottom wall 13 when the reservoir is full of fluid.

The fluid reservoir R presents a configuration that is entirely conventional with its pot 1, which is more particularly for containing a viscous fluid such as cream, gel, pomade, etc.

In the invention, the fluid reservoir R also includes a dish C that is engaged in stationary and leaktight manner in the neck 10 in such a manner as to close its wide opening. The dish C comprises a main body 3 and a stopper 4 that are associated with each other in FIG. 1. The main body 3 includes a projecting peripheral rim 30 for bearing axially against the top edge of the neck 10. The rim 30 is extended inwards and downwards by a collar 31 of shape that is cylindrical and that comes into engagement inside the neck 10. The collar 31 is extended downwards and inwards by a frustoconical section 32 that is itself extended radially inwards so as to form a central opening 35. The main body 3 may also form an outer first annular sealing lip 33 that projects upwards. The main body 3 may form an inner second annular sealing lip 34 that is advantageously adjacent to the opening 35. The second sealing lip 34 is arranged coaxially inside the outer sealing lip 33 and also extends upwards. This particular configuration of the main body 3 should not be considered as limiting: specifically, the shapes of numerous portions may be modified without going beyond the ambit of the invention. For example, it is possible to envisage a main body 3 that does not have a frustoconical section 32. It is also possible to envisage a main body 3 that forms only one sealing lip, or none. It is also possible to envisage that the opening 35 is situated at the same level as the rim 30. However, it is essential that the main body 3 is received in leaktight, and advantageously permanent, manner inside or on the neck 10. It is also preferable for the main body 3 to define an opening 35 for the stopper 4, as described below.

In this respect, the stopper 4 includes an outer flange 44 that is engaged in leaktight manner in the opening 35, and more particularly inside the inner annular sealing lip 34. With reference briefly to FIG. 5, it should also be observed that the flange 44 may be provided with an annular snap-fastener groove 44a that is suitable for co-operating with a projecting profile that is formed inside the lip 34 so as to guarantee both stable fastening and annular sealing. Advantageously, the stopper 4 also forms holder means 41 via which the stopper may be gripped and held firmly. By way of example, the holder means 41 may be in the form of a grip housing, advantageously formed with vertical contact splines arranged on its periphery. It is also possible to envisage holder means in the form of a rod formed with fastener profiles. It is also possible to envisage holder means in the form of a snap-fastener housing. Any configuration or characteristic that makes it possible to make a connection with the stopper 4 constitutes holder means.

Thus, in the closed initial position shown in FIG. 1, the stopper 4 closes the central opening 35 formed by the main body 3 in leaktight manner. No fluid is able to pass through the dish C. Sealing may be obtained by means of the sealing flange 44 being in leaktight engagement with, and advantageously snap-fastened to, the inner sealing lip 34. In a variant shown in FIG. 2, it is also possible to make a stopper 4′, still provided with holder means 41, that is formed integrally as a single piece with the main body 3, being connected thereto via an annular rupture zone 43 that may be in the form of a thin annular film for breaking easily. In both embodiments, the stopper 4, 4′ closes the central opening 35 of the main body 3 in leaktight manner. This corresponds to the closed initial position that enables the fluid stored in the pot 1 to be preserved, protected from the outside environment.

Reference is made below to FIG. 3 which shows the FIG. 1 fluid reservoir R ready to be associated with a dispenser member D that may incorporate a pump or a valve. In entirely general manner, the function of the dispenser member D is to take the fluid contained in the reservoir R, and to dispense it so that it can be used by a user. In non-limiting manner, the FIG. 3 dispenser member D incorporates a pump that forms a pump chamber 71 of variable volume. To do this, the pump includes an elastically-deformable diaphragm 7 that is deformed by pressing on a pusher 8. The diaphragm 7 is associated with a base 5 that defines a fluid inlet 55 in the form of a plurality of inlet orifices that are distributed in annular manner around an axial tube 51 that extends downwards. The tube 51 advantageously serves to anchor an inlet valve member 6 that is suitable for selectively closing the fluid inlet 55. The valve member 6 includes an anchor stub 61 that is engaged inside the central tube 51, as can be seen very clearly in FIG. 5. The base 5 forms an annular space 54 around the central tube 51: the inlet orifices forming the inlet 55 are arranged at this annular space 54 all around the central tube 51. It should also be observed that the base 5 forms an annular sealing groove 53 that extends in coaxial manner around the annular the space 54. Optionally, the dispenser member D can also include a protective cap 9 that covers and protects the pusher 8. Operation of the dispenser member D is entirely conventional: by pressing on the pusher 8, the volume of the pump chamber 71 decreases, thereby causing the fluid that it contains to be put under pressure in such a manner as to force it through an outlet duct to a dispenser orifice (not shown). Once the pressure on the pusher 8 is relaxed, the volume of the pump chamber 71 increases once again in such a manner as to create suction that causes the inlet valve member 6 to open, and fluid to penetrate into the pump chamber 71 through the inlet 55.

In the invention, the central tube 55 of the base 5 serves as a thrust element that is suitable for coming into engagement with the holder means 41 of the stopper 4 so as to move it in translation from its closed initial position (FIGS. 1, 2, and 3) to its open final position (FIGS. 4 and 5). More precisely, the free bottom end of the thrust element 51 penetrates, with friction, into the holder means 41 that are made in the form of an upwardly-open housing. FIG. 3 shows the thrust element 51 at the moment when it comes into engagement with the holder means of the stopper 4. It can easily be understood that downward movement of the dispenser member D onto the reservoir R has the effect of engaging the bottom end of the central tube 51 inside the holder housing formed by the holder means 41. Then, additional thrust on the dispenser member D, e.g. on its cap 9, causes the stopper 4 to move axially, dislodging it from the main body 3. This is shown in FIGS. 4 and 5. It can be seen that the sealing flange 44 is no longer in leaktight contact with the inside lip 34 and is disengaged from the central opening 35 so as to form a feed opening O that is defined between the stopper 4 and the main body 3. More precisely, as can be seen in FIG. 5, the feed opening O is formed between the top of the sealing flange 44 and the base of the sealing lip 34. The feed opening O enables the fluid stored in the reservoir to reach the orifices forming the fluid inlet 55. It can clearly be seen that the thrust element 51 is engaged inside the holder means 41 in completely stable manner, such that the positioning of the stopper 4 is accurate and determined relative to the main body 3. It can also be said that movement of the stopper 4 makes it possible to put the central opening 35 into communication with the annular space 54.

In FIG. 5, it should also be observed that the inner sealing lip 34 is received inside the annular space 54 in such a manner as to create a cylindrical annular sealing zone. In addition, with reference once again to FIG. 4, it can be seen that the outer sealing lip 33 is received inside the annular sealing groove 53 that is formed by the base 5. Once again, an annular sealing zone is formed that advantageously extends around the first annular sealing zone formed by the inner lip 34. In this way, complete sealing is guaranteed between the dispenser member D and the dish C of the reservoir R. It should also be observed that the configuration of the bottom portion of the dispenser member D is adapted to match the dish C. In order to fasten the dispenser member D on the reservoir R, it is possible to provide a screw-fastening for example, so as to enable quick and easy separation, e.g. for the purpose of putting a new full reservoir in place as a refill or a cartridge.

The invention thus provides a closure element that is incorporated in the neck of the reservoir and that makes it possible to create a feed opening O of determined size and configuration, without creating any loose part or element that could hinder the operation of the dispenser. The embodiment used to illustrate the present invention is adapted very particularly to a dispenser member that is fitted with a central thrust element and with a peripheral fluid inlet, but it is possible to envisage other embodiments that are adapted to a dispenser member having an inlet that is central, with a peripheral thrust element that is suitable for creating fluid communication between the reservoir and the pump chamber 71. It should also be observed that removing the dispenser member D from the reservoir R causes the stopper 4 to be put back into place in the central opening 35 of the main body 3, so as to close the reservoir in leaktight manner, thereby returning it into its closed initial position.

1. A fluid reservoir including a neck defining a wide opening that is closed by a dish in stationary and leaktight engagement with the neck, the reservoir being characterized in that the dish comprises a main body in engagement with the neck and a stopper that is mounted on the main body in removable manner, the stopper being movable between a closed initial position in which the stopper is mounted on the main body in leaktight manner, and an open final position in which a feed opening is formed between the main body and the stopper.

2. A reservoir according to claim 1, wherein the stopper is separate from the main body in its open final position.

3. A reservoir according to claim 1, wherein the feed opening is annular.

4. A reservoir according to claim 1, wherein the stopper includes holder means that are suitable for coming into engagement with an external thrust element so as to move it from its closed initial position to its open final position.

5. A reservoir according to claim 1, wherein the stopper is snap-fastened in the main body in its closed initial position.

6. A reservoir according to claim 1, wherein the stopper in its closed initial position is formed integrally as a single piece with the main body.

7. A reservoir according to claim 1, wherein the main body defines at least one annular sealing lip that projects upwards.

8. A reservoir according to claim 7, wherein the stopper is mounted in the annular sealing lip in the closed initial position.

9. A reservoir according to claim 1, wherein the stopper is movable axially in translation relative to the main body between its closed initial position and its open final position.

10. A fluid dispenser comprising a dispenser member, such as a pump, associated with a fluid reservoir according to claim 1, the dispenser member including a thrust element that comes into engagement with the stopper so as to move it from its closed initial position to its open final position.

11. A dispenser according to claim 10, wherein the thrust element holds the stopper in its open final position.

12. A dispenser according to claim 10, wherein the dispenser member includes a chamber in which the fluid is put under pressure, the chamber including at least one inlet that communicates with the reservoir, the inlet being arranged around the thrust element.

13. A dispenser according to claim 10, wherein the dispenser member forms at least one annular sealing groove in which an annular sealing lip that is formed by the dish is received.
